(19) United States
(12) Patent Application Publication
(10) Pub. No.: US 2006/0144690 A1
(43) Pub. Date: Jul. 6, 2006

(54) UV target for an environmental air sterilization apparatus

(76) Inventors: Ronald G. Fink, Jupiter, FL (US); Walter Ellis, Jupiter, FL (US); Charles Pearsall, Stuart, FL (US)

Correspondence Address: BOC, INC., 575 MOUNTAIN AVE, MURRAY HILL, NJ, 07974-2064, US

(21) Appl. No.: 11/208,662

(22) Filed: Aug. 22, 2005

Related U.S. Application Data
(63) Continuation of application No. 10/064,154, filed on Jun. 14, 2002.

(51) Int. Cl. C01B 13/00; B01J 19/12

(52) U.S. Cl. 204/157.5; 422/186.3

(57) ABSTRACT

The present invention is a high volume, wall-mountable air sanitation apparatus for disinfecting and removing VOC's with high energy UV light and ozone. The apparatus has a powerful fan and an elongated UV light source and target for use with the movement of a large volume of air. The target includes a mesh and a secondary target both comprising a target compound which creates hydro-peroxides, super oxide ions and hydroxyl radicals in the presence of water also for removing pollutants in the air.

### CROSS REFERENCE TO RELATED APPLICATIONS

The present application is a continuation of U.S. Ser. No. 10/064,154, filed Jun. 14, 2002, from which application priority is claimed under 35 U.S.C. § 120.

### BACKGROUND OF INVENTION

This invention relates to an air treatment apparatus, and more particularly to a wall-mountable, high volume air treatment apparatus for the removal of contaminants such as pollutants, organisms and odors from air.

Airborne pollutants, organisms and odors are all major concerns in indoor air quality assessment. Solid pollutants such as dust or other particulates may be removed by a filtering mechanism. However, organic compounds and organisms in atmosphere are more difficult to remove by filter, and need a very fine filter or other specialized equipment. Chemicals and bactericidal agents are known in the prior art to combat airborne organisms. Deodorants are known in the art to mask odors that may be found in the indoor air, but they do nothing to actually eliminate those odors. Unfortunately, chemicals and bactericidal agents must be replaced regularly and are not always effective in the elimination of the pollutants and organisms. In fact, the misuse of bactericidal agents may actually cause the mutation of the bacteria into strain resistant to that agent.

The use of ozone is commonly known in the prior art for freshening air and removing odors. Ozone is generated by a variety of methods. One known method is to subject air to high intensity UV light, such as that at approximately 185 nm. The flow of oxygen over the UV light, and the dimensions of the light, and the intensity of the light are known to be important factors in generating ozone, because it is commonly known that high concentrations of ozone are undesirable for humans. In fact, most literature teaches away from the use of high intensity UV light to treat air because of the danger to humans. Systems known in the art which use ozone to freshen air and remove odors do not effectively remove organic pollutants and organisms. Moreover, these systems are incapable of handling large volumes of air.

Hydro peroxides, super-oxide ions and hydroxyl radicals are known to oxidize volatile organic compounds (VOCs). These radicals and ions also kill and decompose airborne bacteria and other airborne organisms. This process is known as heterogeneous photocatalysis or photocatalytic oxidation (PCO). PCO is particularly desirable for treating VOCs because these materials are oxidized and are therefore eliminated rather than merely captured or removed from the airstream. Thus PCO is preferable to a filter mechanism, because filters must be replaced or cleaned regularly. PCO reactors also have low power consumption, long service life and low maintenance requirements. Also, a filtration system would be expensive and impractical for the cleansing of large volumes of air. Moreover, using several small units for freshening air would be overly expensive and still would not efficiently cleanse a large volume of air.

Thus, there is no viable apparatus for effectively freshening air and removing odors from a large volume of air.

There is also no wall-mounted apparatus that could effectively freshen air and remove odors.

There is no effective means for freshening a large volume of air that safely and efficiently uses ozone, hydro peroxides, super oxide ions and hydroxyl radicals.

It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### SUMMARY OF INVENTION

The present invention comprises a high volume, wall-mountable air sanitation apparatus for disinfecting and removing VOCs from air with an elongated high energy UV light source and ozone, comprising a casing, a means for moving air, the air moving across at least one elongated target comprising a target compound, said target compound comprising at least one selected from the group consisting of titanium dioxide, copper and silver; and a high energy UV light source adapted to direct UV light toward the air and the target whereby the UV striking the air and the target will generate at least one selected from the group of hydro-peroxides, super-oxide ions and hydroxyl radicals. It is preferred that the target compound further comprises approximately 0-30% titanium dioxide, 0-30% silver, and 0-30% copper, by weight. It is also preferred that the target compound further comprises a hydration compound of silica gel.

The preferred shape of the target is a mesh at least partially located between the UV light source and the air. The UV light source emits UV light at a wavelength of approximately 185 nm. In the preferred embodiment, the UV light source emits UV light at between 185 nm and 254 nm. In an alternative embodiment, the target further comprises a secondary element located a predetermined distance from the wire mesh, whereby at least a portion of the UV light coming through the mesh strikes the secondary element. It is also preferred that the secondary element is made of a target compound comprising approximately 0-30% titanium dioxide, 0-30% silver, and 0-30% copper, by weight.

It is preferred that the apparatus includes a fan located in the interior of the casing. Also, a particulate filter may be included for removing particulates from the air before the air is moved over the target compound. When in use, reflected and refracted UV light is visible from the exterior of the casing through the blades of the fan.

The UV light source comprises one or more UV lights. The UV lights are preferably mercury vapor UV light sources capable of emitting between approximately 185 nm UV light and approximately 254 nm UV light. Preferably, at least one separate mesh target surrounds each UV light. However, a single mesh target may be affected by more than one UV light source.

The invention is also an apparatus for efficiently disinfecting and removing VOCs from air with high energy UV light, comprising a high energy UV light source capable of generating ozone from oxygen in air, a mesh target located at least partway between the high energy UV light source and the air, the target including a target compound comprising at least one selected from the group consisting of titanium dioxide, copper and silver, whereby the UV light and the target compound generate in the presence of water at least one selected from the group of hydro-peroxides, super-oxide ions and hydroxyl radicals; and a secondary target element located a predetermined distance from the mesh target, the secondary target element including the target compound, whereby at least a portion of the UV light that passes through the mesh target strikes the secondary target element, thereby generating additional hydro-peroxides, super-oxide ions and hydroxyl radicals to that generated by the mesh target. It is also preferred in this embodiment that the air generally flows between the mesh target and the secondary target. Also, it is preferred that the secondary target acts as a conduit for the moving air.

The preferred target compound includes a hydration compound of silica gel. The preferred UV light source is one or more mercury vapor UV lights of a predetermined geometry.

The invention is also a wall-mountable method for treating a large volume of air, comprising: directing the large volume of air toward a target comprising a target, said target comprising a compound consisting of titanium dioxide, silver and copper; and directing UV light toward the target, said the UV light being at a wavelength sufficient to generate ozone from oxygen in the air and being sufficient to generate at least one selected from the group consisting of hydro-peroxides, super-oxide ions and hydroxyl radicals from interaction with the compound in the presence of water.

In this method, the target may be solely a mesh located generally between the air and the UV light. Alternatively, the target may include a secondary element located a predetermined distance form the mesh whereby the air generally passes between the mesh and the secondary element and UV light passing through the mesh strikes the secondary target element, thereby generating additional hydro-peroxides, super-oxide ions and hydroxyl radicals to that generated by the mesh target.

It is therefore an object of the present invention to provide a viable apparatus for effectively freshening air and removing odors from a large volume of air.

It is another object of the present invention to provide a wall-mounted apparatus that could effectively freshen air and remove odors.

It is another object of the present invention to provide an apparatus and a method for freshening a large volume of air that safely and efficiently uses ozone, hydro-peroxides, super oxide ions, hydroxyl radicals and UV radiation.

It is to be understood that both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF DRAWINGS

For a fuller understanding of the nature and objects of the invention, reference should be made to the following detailed description, taken in connection with the accompanying drawings, in which:

FIG. 1 is a top perspective view of the preferred embodiment of the invention.

FIG. 2a is a top view of a cover plate of the invention.

FIG. 2b is a side view of a cover plate of the invention.

FIG. 2c is an end view of the lip of the cover plate.

FIG. 3a is a top view of a top panel of the invention.

FIG. 3b is a side view of a top panel of the invention.

FIG. 3c is an end view of a top panel of the invention.

FIG. 4a is a top view of a bottom panel of the invention.

FIG. 4b is a side view of a bottom panel of the invention.

FIG. 4c is an end view of a bottom panel of the invention.

FIG. 5a is a top view of a chassis of the invention.

FIG. 5b is a side view of a chassis of the invention.

FIG. 5c is an end view of a chassis of the invention.

FIG. 6a is a side view of a mesh target of the invention.

FIG. 6b is an end view of a mesh target of the invention.

FIG. 7a is a top view of a lamp support tray of the invention.

FIG. 7b is a side view of a lamp support tray of the invention.

FIG. 7c is an end view of a lamp support tray of the invention.

FIG. 8a is a top plan partially cut away view of the invention.

FIG. 8b is an end plan view of the invention.

FIG. 9 is a front plan partially cut away view of the invention.

FIG. 10 is a bottom plan partially cut away view of the invention.

FIG. 11 is a perspective partially cut away view of an alternative embodiment of the invention.

### DETAILED DESCRIPTION

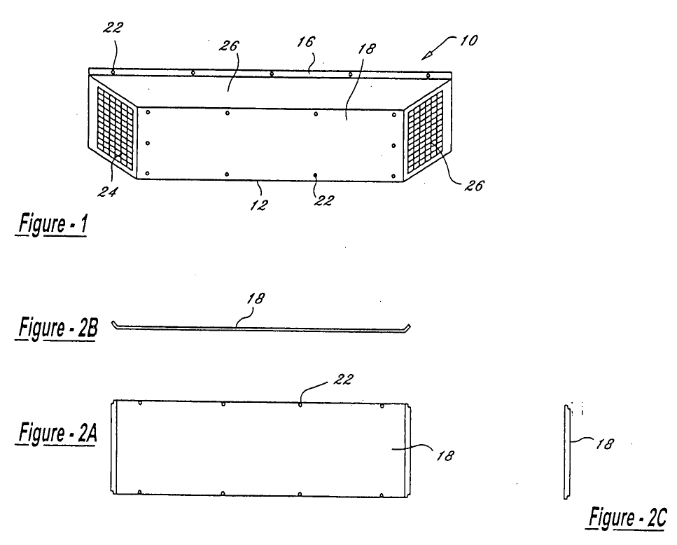

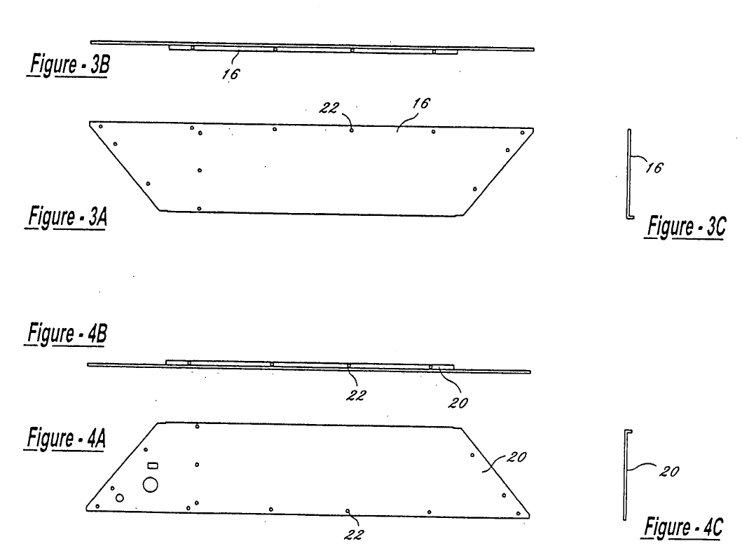

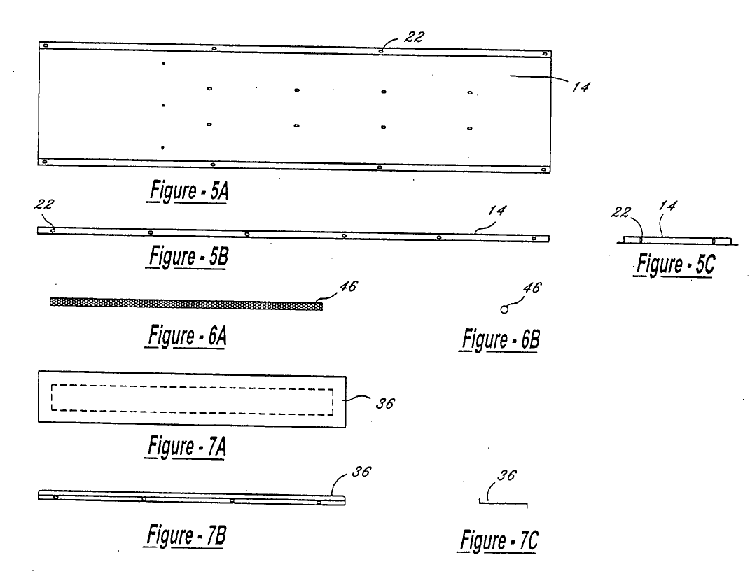

FIG. 1 shows the present invention: a high volume, wall-mountable air sanitation apparatus for disinfecting and removing VOCs from air with high energy UV light and ozone, shown generally as 10. The invention has a casing 12 mountable onto a wall. It is preferred that the casing 12 comprise a chassis 14, a top panel 16 a front panel 18, and a bottom panel 20, shown in detail in FIGS. 2-5. Other geometries for the casing 12 may alternatively be used. In addition, the casing 12 preferably comprises an air intake grill panel 24 on one side and air exhaust grill panel 26 on the other side. However, the air intake grill panel 24 and the air exhaust grill panel 26, as well as the air intake and exhaust functions described herein, may be reversed. As shown, each of the panels to the casing 12 and the chassis 14 has points 22 for attachment, so the casing may be assembled. The panels and chassis may be attached by screws, bolts, friction or other means known in the art. The chassis 14 and panels are preferably made from a rigid material to withstand the stresses of the movement of a high volume of air, such as stainless steel. In addition, the chassis 14 and the panels are preferably assembled so that the interior of the apparatus 10 may be accessed while the apparatus 10 is attached to a wall. Other means for forming a casing 12, such as a removable one-piece cover over the chassis 14 may be preferable.

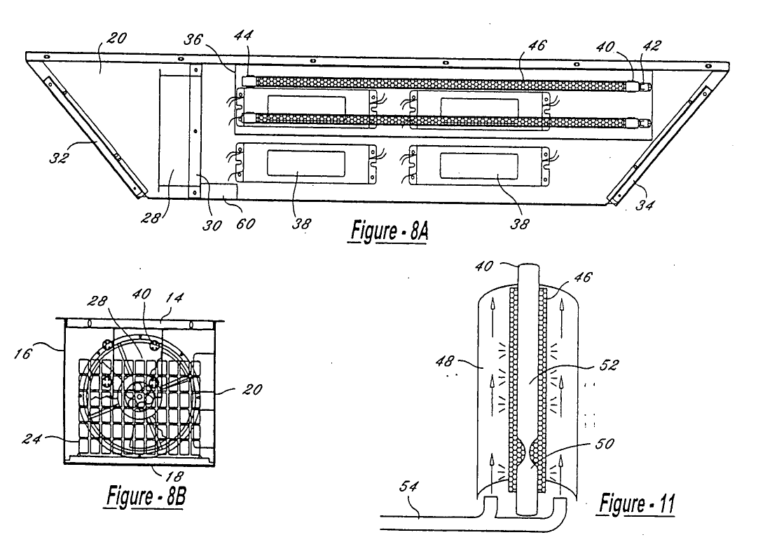

FIGS. 8a and 8b, a removable filter 32 may be placed within the casing 12 inside the air intake grill panel 24. For added sanitization of the air moving through the casing 12, a second removable filter 34 may also be placed within the casing 12 in front of the air exhaust grill panel 26. The second removable filter 34 also aids in shielding any UV light that may otherwise be emanating from the apparatus 10. However, in an alternative embodiment, some reflected or refracted UV light may be observable from outside the apparatus 10. A high-pressure fan 28 is placed within the casing 12 to move air through the apparatus 10. The fan 28 is mounted into the casing 12 by a mounting bracket 30 as shown in FIGS. 8-10. Preferably, the fan 28 moves sufficient air so that the apparatus 10 is capable of sanitizing the air in a room of approximately 200,000 square feet, or more.

As FIG. 8a, attached to the bottom panel 20 is a lamp support tray 36. The preferred geometry of the lamp support tray 36 is provided in FIGS. 7a-7c. However, depending upon the geometry of the casing 12 and of the light source used, other geometries may be used and may be preferred. It is preferred that the lamp support tray 36 is made of a rigid material like a metal such as stainless steel. Alternatively, lamp brackets may be mounted within the apparatus to house the elongated UV light sources 40. The lamp support tray 36 or lamp brackets may be attached by being bolted, welded or screwed to the bottom panel 20, or other means known in the art.

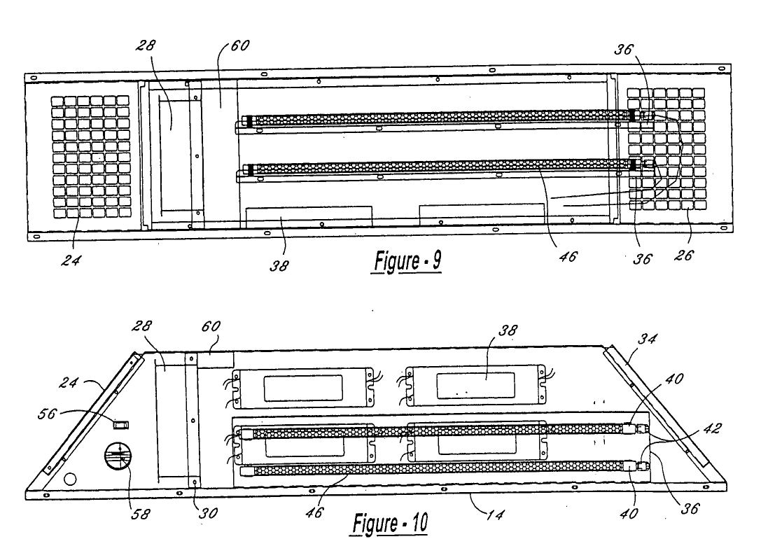

As in FIGS. 8 and 9, attached to the lamp support tray 36 are one or more ballast circuits 38 in electronic communication with one or more elongated UV light sources 40. Preferably, the UV light source 40 is a low-pressure mercury vapor lamp. However, medium pressure mercury lamps and other equivalent UV light sources are known in the art. The UV light source 40 preferably emits at least some UV light of approximately 185 nm. In the preferred embodiment, the UV light source 40 is a combination UV light source capable of emitting between approximately 185 nm and approximately 254 nm UV light. Also, as shown in FIG. 10, in the preferred embodiment the bottom panel includes a power switch 56 and an hour meter 58 to show the duration that apparatus 10 has been active. The hour meter 58 thus helps the user to determine a schedule for maintenance.

The preferred UV light source 40 is shown generally in FIG. 11. The preferred UV light source 40, as shown, has a portion 50, which emits mostly approximately 185 nm UV light, and a portion 52, which emits mostly approximately 254 nm UV light. For the UV light source 40 shown, it is preferred that the portion of the UV light source 40 capable of emitting 185 nm UV light 50 is mounted toward the air intake grill panel 24. Thus, the concentration of ozone created by the 185 nm UV light source 40 will have at least partially dissipated when the air passes through the exhaust grill panel 26.

The elongated UV light source 40 is preferably attached to the lamp support tray 36 by means such as a 4-pin connector 42 and a lamp clip 44 that is attached to the light support tray by means such as riveting. Also as shown in FIG. 8a, attached to the bottom panel 20 is a support 60 for the fan mounting bracket 30. This support 60 allows the apparatus 10 to have a powerful fan within it for rapidly moving a large volume of air. As shown in FIGS. 8-10, the UV light sources 40 may be arranged in a rectangular geometry. However, other geometries may be preferred, such as triangular, hexagonal or circular, depending upon the number and size of UV light sources used.

Around each UV light source 40 is preferably a mesh target 46. The preferred geometry of the mesh target 46 is illustrated in FIGS. 6a and 6b; however, other geometries may be used, depending upon the size, shape and intensity of the UV light source used the amount of interaction with the UV light desired by the user. The mesh target 46 allows part of the UV light reaching the mesh target 46 to pass through it. The mesh target 46 preferably comprises a target compound. However, it may also comprise a UV transparent material. The target compound is preferably comprised of a combination of titanium dioxide, copper and silver formed in a hydration compound of silica gel. It is preferred that the target compound is approximately 0-30% titanium dioxide, 0-30% silver, and 0-30% copper by weight. Air that is pushed by the fan passes over the UV light source 40 and the mesh target 46. The UV light interacts with the oxygen in the air to form ozone, which destroys biological pollutants in the air. In addition, in the presence of water, the UV light interacts with the target compound to form hydro-peroxides, super oxide ions and hydroxyl radicals, which combine with VOCs in the air passing through the apparatus 10, thereby reducing the VOCs where the apparatus is used. In addition, the UV light itself destroys biological pollutants in the air.

The ambient humidity may provide the apparatus with enough water to form the hydro-oxides, super oxide ions and hydroxyl radicals. However, in an alternative embodiment, the emitted UV light also interacts with the target compound in the mesh target 46 in the presence of a mist of water supplied by a mister to form the hydro peroxides ions, super oxide ions and hydroxide radicals that act to neutralize VOCs and other organic pollutants in the air passing through the apparatus 10. In an alternative embodiment, illustrated in FIG. 11, a mister 54 is attached to the apparatus 10. The creation of the hydro peroxides ions, super oxide ions hydroxide radicals is optimized where the mist from the mister 54 is introduced into the apparatus 10 approximately after the intake fan 28 and approximately before the 185 nm emitting portion of the UV light source 50. It is preferred that the mister 54 uses high purity water to prevent contamination of the apparatus 10 or the addition of pollutants into the air. In addition, it is preferred that the mist is formed by ultrasonically agitating a reservoir of ultra pure water. In the preferred embodiment the mister 54 also includes a baffle to prevent large droplets or splashing of the water in the reservoir from entering the apparatus 10. In addition, a manually or mechanically controlled flow controller for the mister 54 to control the amount of mist entering the apparatus 10 is preferred.

Also in an alternative embodiment, several layers of mesh target 46 are used so that air flows between the layers of mesh targets 46. This configuration increases the efficiency of the use of the target compound with the UV light.

In yet another embodiment, a secondary target 48 comprising target compound is placed a predetermined distance from the mesh target 46 so that UV light passing through the mesh target 46 strike the secondary target 48. thus, increased ozone and hydro peroxide and super oxide ions are produced in the air stream passing generally between the mesh target 46 and the secondary target 48.

The secondary target 48 may be target compound formed on the inside surface of the casing 12. In an alternative embodiment, as illustrated in FIG. 11, the UV light source 40 may be surrounded by the mesh target 46. The secondary target 48 is located a predetermined distance from the mesh target 46. Consideration of the UV light intensity, the length of the path of the air over the UV light and mesh target, and the speed and volume and components of the air passing over the mesh is made in determining the distance of the secondary target 48 from the mesh target 46. It is preferred that the secondary target, as well as the mesh, surrounds the UV light source 40 completely for optimum efficiency. Moreover, to ensure optimum efficiency, it is preferred that the secondary target 48 itself acts as a conduit for the moving air. However, the mesh target 46 and the secondary target 48 may alternatively only partly surround the UV light source. While it is shown in FIG. 11 that the mister introduces the mist between the mesh target 46 and the secondary target 48, other configurations for the introduction of the mist are contemplated.

It will be seen that the objects set forth above, and those made apparent from the forgoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween, now that the invention has been described.

1-21. (canceled)

22. A target for generating at least one oxidant selected from the group consisting of hydro-peroxides, super-oxide ions and hydroxyl radicals in the presence of air when the target and air are struck by UV light in the presence of water, the target comprising a target compound, said target compound comprised of titanium dioxide in combination with at least one selected from the group consisting of up to about 30% by weight copper and up to about 30% by weight silver.

23. The target of claim 22, wherein the target compound further comprises a hydration compound of silica gel.

24. The target of claim 22, wherein the target compound comprises a combination of titanium dioxide, copper, silver and silica gel.

25. The target of claim 22, wherein the target comprises a mesh at least partially located between a source of the UV light and the air.

26. The target of claim 25, disposed to at least partly surround the UV light source.

27. The target of claim 25, wherein the UV light source comprises at least one of a low-pressure mercury vapor lamp, or a medium pressure mercury vapor lamp.

28. The target of claim 27, comprising at least one mesh target disposed to surround each low-pressure mercury vapor lamp or medium pressure mercury vapor lamp.

29. The target of claim 25, wherein the UV light source is capable of generating ozone from oxygen in the air.

30. The target of claim 22, wherein the UV light source emits UV light at a wavelength of approximately 185 nm to 254 nm.

31. A method for treating air, comprising:
exposing the air to a target comprising a target compound, said target compound comprised of titanium dioxide, in combination with at least one selected from the group consisting of up to about 30% by weight silver and up to about 30% by weight copper;
directing UV light toward the target, said UV light being at a wavelength sufficient to generate ozone from oxygen in air and to generate at least one oxidant selected from the group consisting of hydro-peroxides, super-oxide ions and hydroxyl radicals from interaction with the target compound in the presence of water.

32. The method of claim 31, wherein the water comprises ambient humidity.

33. The method of claim 31, including supplying a mist of water.

34. The method of claim 31, wherein the target compound further comprises a hydration compound of silica gel.

35. The method of claim 31, wherein the target compound comprises a combination of titanium dioxide, copper, silver and silica gel.

36. The method of claim 31, wherein the target comprises a mesh at least partially located between a source of the UV light and the air.

37. The method of claim 36, wherein the target is disposed to at least partly surround the UV light source.

38. The method of claim 37, further comprising passing air over the UV light source and the mesh target.

39. The method of claim 37, wherein the target acts as a conduit for the air.

40. The method of claim 37, including providing a secondary target, wherein air flows between the mesh target and the secondary target.

41. The method of claim 40, including introducing a mist of water between the mesh target and the secondary target.
